(19) United States
(12) Patent Application Publication
(10) Pub. No.: US 2020/0313168 A1
(43) Pub. Date: Oct. 1, 2020

(54) LITHIUM ION BATTERY ELECTRODE WITH MULTIPLE-GRAPHITE COMPOSITE

(71) Applicant: SF Motors, Inc., Santa Clara, CA (US)

(72) Inventors: Yu-Hsin Huang, Milpitas, CA (US); Chien-Po Huang, Campbell, CA (US); Ying Liu, Santa Clara, CA (US); Yifan Tang, Santa Clara, CA (US); Chengyu Mao, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/368,825

(22) Filed: Mar. 28, 2019

(51) Int. Cl. H01M 4/1393; H01M 4/62; H01M 4/04; H01M 10/0525

(52) U.S. Cl. CPC H01M 4/1393; H01M 4/625; H01M 4/621; H01M 10/0525; H01M 4/0404

(57) ABSTRACT

An electrode for a lithium ion rechargeable battery, wherein the electrode is made from a slurry generated from a compound graphite active material. The compound graphite active material can include graphite particles of different sizes. In some instances, fifty percent or more of the graphite particles making up the active material can have a diameter that is larger than the diameter of the remainder of the graphite materials. The compound graphite active material is applied to a current conductor to form an electrode, and provides for a discharge capacity of significantly higher than lithium ion rechargeable battery having an electrode with a slurry generated from a single sized graphite active material.

### BACKGROUND

Rechargeable lithium-ion batteries have become very popular in devices that utilize a rechargeable power source, such as for example cellular phones, electric vehicles, and other products. Lithium-ion batteries typically include electrodes wherein with a slurry applied to the surface of a current conductor. The slurry is formed at least from an active material and a binder that are mixed together. The active material used in anode typically includes graphite, which reacts with lithium ions during charge and discharge of the battery cell.

The power performance (discharge capability) of Li ion cells is critical for electric vehicles (EVs) because it directly governs the acceleration ability of the vehicle. Fast discharging is hard on a lithium ion battery cells on often inefficient. For example, during a discharge at 5 C, many rechargeable lithium batteries operate at 25% capacity or less. What is needed is an improved lithium-ion battery that operates better during fast discharging scenarios.

### SUMMARY

The present technology, roughly described, includes a lithium ion rechargeable battery having an electrode with a slurry generated from a compound graphite active material. The compound graphite active material can include graphite particles of different sizes. In some instances, fifty percent or more of the graphite particles making up the active material can have a diameter of a first size and the remainder of the graphite materials can have a diameter of a second size that has a smaller diameter than the first size. The compound graphite active material is applied to a current conductor to form an electrode, and provides for a discharge capacity of significantly higher than lithium ion rechargeable battery having an electrode with a slurry generated from a single sized graphite active material.

In embodiments, an electrode is disclosed which includes a current conductor and slurry. The slurry can be coated on a first surface of the current conductor. The slurry can include an active material having a first plurality of graphite particles, each having approximately a first diameter, and a second plurality of graphite particles each having a second diameter which is less than the first diameter.

In embodiments, a method is disclosed for manufacturing an electrode. The method begins with applying a slurry to a first surface of a current conductor. The slurry can include an active material, a conductive material, and a binder. The active material can include a first plurality of graphite particles that are a first size and a second plurality of graphite particles having a diameter of a second size, the second size being less than first size. The method can also include drying the slurry onto the current conductor.

In some instances, the first plurality of graphite particles comprises a greater volume of the slurry than the second plurality of graphite materials. The slurry can be generated by adding the first plurality of graphite particles with the second plurality of graphite particles in the slurry, and the slurry can include a binder material.

### BRIEF DESCRIPTION OF FIGURES

FIG. 1 is a schematic of an exemplary lithium ion battery under load.

FIG. 2 is a block diagram of a graphite active material having graphite particles having a first size.

FIG. 3 is a block diagram of a graphite active material having graphite particles having a second size.

FIG. 4 is a block diagram of a compound active material having graphite particles with both a first and a second size.

FIG. 5 is a table of discharge capacity for different C-rates and active materials.

FIG. 6 is a block diagram of an electrode generation system applying a slurry to a current conductor.

FIG. 7 is a block diagram of a slurry with a compound active material applied to a current conductor.

FIG. 8 is a block diagram of an electrode generation system trying a slurry that has been applied to a current conductor.

FIG. 9 is a method for manufacturing an electrode with a slurry having a compound active material.

### DETAILED DESCRIPTION

The present technology, roughly described, includes a lithium ion rechargeable battery having an electrode with a slurry generated from a compound graphite active material. The compound graphite active material can include graphite particles of different sizes. In some instances, fifty percent or more of the graphite particles making up the active material can have a first diameter, and the remainder of the graphite materials can have a second diameter, wherein the first diameter is larger than the second diameter. The compound graphite active material is applied to a current conductor to form an electrode, and provides for a discharge capacity of significantly higher than lithium ion rechargeable battery having an electrode with a slurry generated from a single sized graphite active material.

In diameters of the particles may vary, as long as the first diameter is greater than the second diameter. In some instances, a first plurality of particles can have a diameter of between 15 micrometers and 30 micrometers, and the second plurality of particles can have a diameter of between 5 micrometers and less than 15 micrometers, such as for example a larger particle with a diameter of 18 and a smaller particle with a diameter of 10. In some instances, a first plurality of particles can have a diameter ranging from 10 micrometers to 30 micrometers and the second plurality of particles can have a diameter ranging from 2 micrometers to 20 micrometers, such as for example a larger particle with a diameter of 14 and a smaller particle with a diameter of 8.

The current technology relates to a number of technical problems, including but not limited to the challenges of manufacturing more efficient lithium ion batteries. Previous manufacturing techniques apply a slurry having an active material with a single type of graphite particle. The resulting electrode does not perform very efficiently at fast discharging rates, such as 5 C, often times only utilizing 30% of a battery capacity. For users that desire fast discharging batteries, this is not a desired characteristic.

The current technology provides a technical solution to the technical problem of manufacturing lithium-ion batteries. Specifically, the present technology provides an improved lithium-ion battery electrode that is generated with an active material having different sized graphite particles. Having a plurality of graphite particle sizes allows an active material to exhibit benefits of both larger graphite particles and smaller graphite particles. In particular, the larger size graphite particles provide for a beneficial mass transfer while the smaller size graphite particles provide a higher charge transfer. As a result, a battery cell with an electrode made from the active material with different sized graphite particles provides for better battery discharge and charge performance

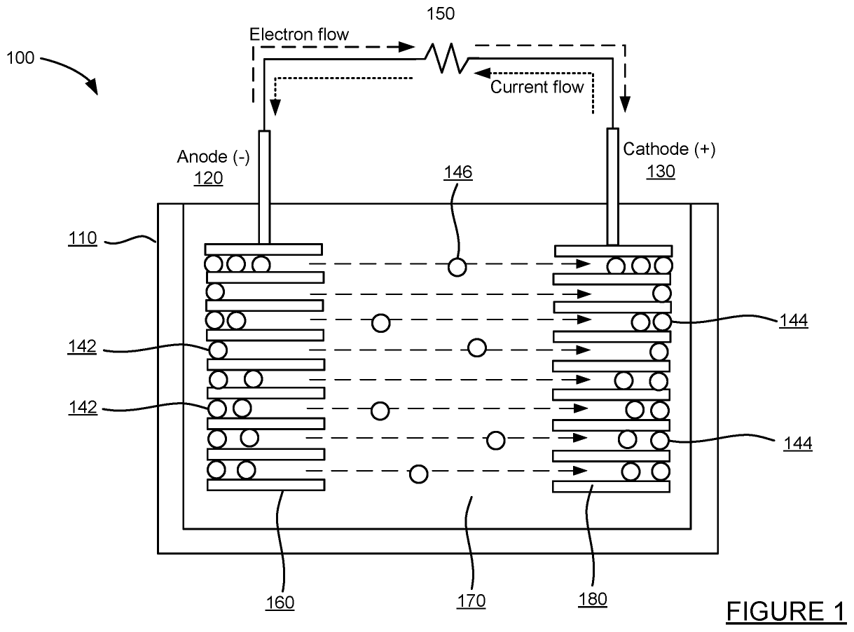

FIG. 1 is a schematic of an exemplary lithium ion battery under load. Battery cell 100 includes anode 120, cathode 130, lithium ions 142, 144, and 146, and electrolyte 170. The anode includes active material 160 and the cathode material includes active material 180. Electrolytes 170 are placed in a battery cell container 110 with the anode material 160 and cathode material 180. During discharge, the lithium ions 142 collected at the anode active material 160 move through the electrolyte 170 (see lithium ions 146) to position at and within the cathode active material 180 as lithium ions 144, resulting in a potential applied to load 150. During discharge, electrons travel from the anode to the cathode, causing current to travel from the cathode to the anode.

When the lithium battery is charged, a potential is applied between the anode and cathode. During charging, lithium ions 144 move from the positive cathode electrode 130 through the electrolyte (see lithium ions 146) and towards the negative anode electrode 120, where the lithium ions 142 are embedded into the anode active material 160 via intercalation. The electrons travel from the cathode to the anode, causing current to travel from the anode to the electrode.

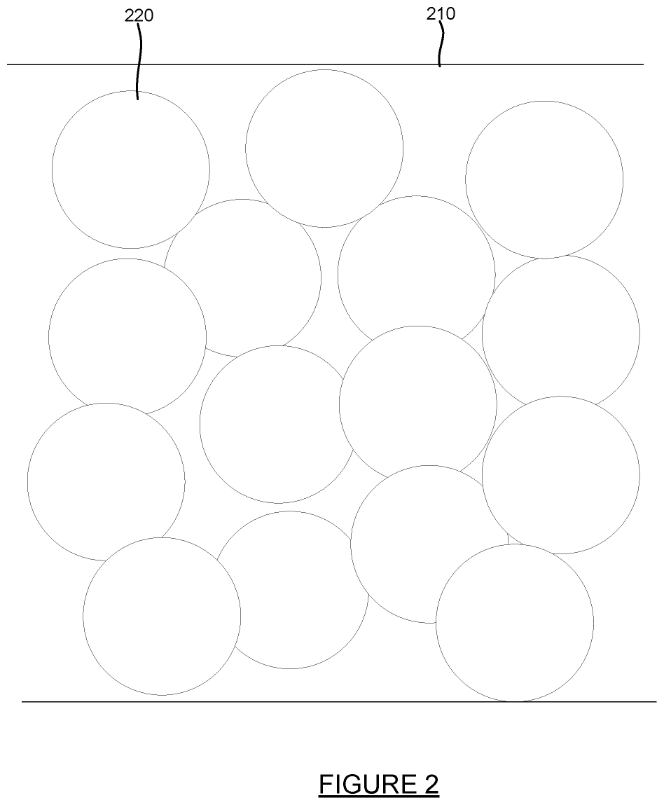

As shown in FIG. 1, lithium-ion's embedded into an active material through intercalation exit the anode material, travel through an electrolyte, and are embedded in a cathode. The anode active material can be formed from carbon in the form of graphite particles. FIG. 2 is a block diagram of a graphite active material having graphite particles with a first size. A larger size of graphite particle requires lithium ions to be embedded further within graphene layers of a graphite particle. Another aspect of large graphite particles is there are larger spaces between the particles, thereby making it easier for lithium ions to travel between the anode particles.

The graphite active material 210 of FIG. 2 includes graphite particles 220 having a diameter of, for example, 8 μm (microns) or greater. In some instances, the particles 220 have a diameter of at least 10 microns, at least 12 microns, at least 14 microns, at least 15 microns, or at least 16 microns, and as big as 30 microns. These particles are considered relatively larger in size compared to other particles having a smaller diameter that are used to form an active material for a slurry, and provide a benefit in terms of better mass transfer then graphite particles having a smaller size. However, larger graphite materials are associated with a lower charge transfer then graphite particles having a smaller particle size.

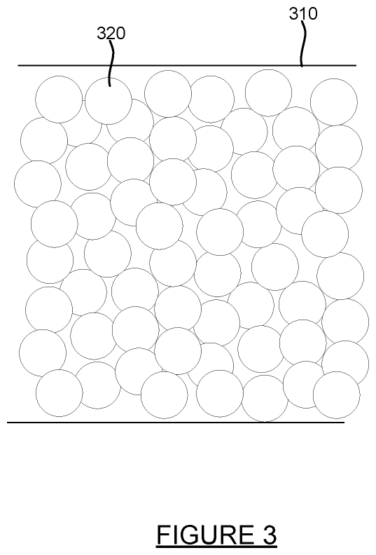

FIG. 3 is a block diagram of a graphite active material 310 having graphite particles 320 with a second size. The graphite particles 320 of FIG. 3 have a smaller diameter, for example less than 20 microns, less than 18 microns, less than 16 microns, less than 15 microns, less than 14 microns, less than 12 microns, or less than 10 microns. In some instances, the particles 230 have a diameter that is smaller than the larger graphite particles of FIG. 2. Correspondingly, the smaller graphite particles have less space between them than the larger graphite particles of FIG. 2. Less space between the particles means there are fewer paths for lithium ions to travel within electrolytes. An active material with graphite particles having a smaller size than those of FIG. 3 exhibits a higher charge transfer than an active material having larger graphite particles such as those of FIG. 2. However, the smaller graphite particles are associated with a smaller mass transfer then the particles of FIG. 2. Hence, slurries with an active material of purely larger graphite particles or purely smaller graphite particles each have disadvantages.

The graphite particles and other elements illustrated in FIGS. 1-4 and 6-7 are not to scale, and are provided for exemplary discussion purposes. The scale of the particles, with respect to each other and other elements in the FIGURES discussed herein, is not intended to be exact and the present technology is not limited to the scale of any elements in FIGS. 1-4 and 6-7.

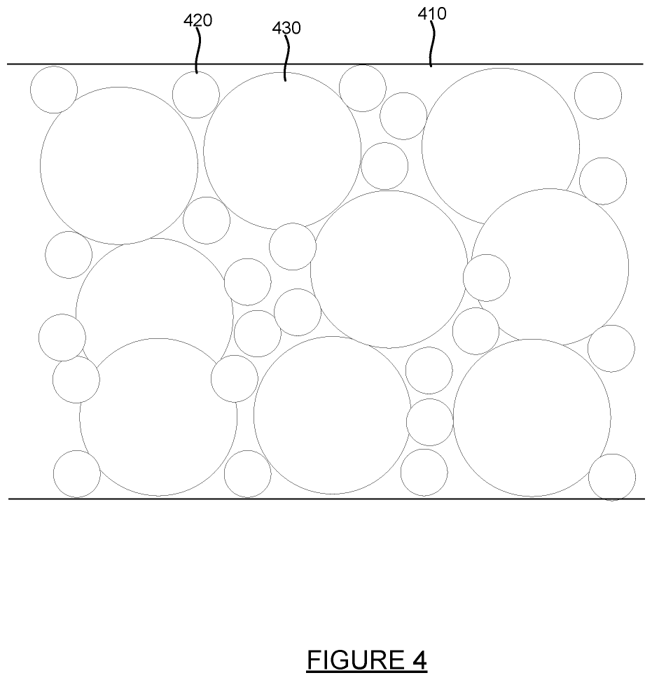

FIG. 4 is a block diagram of a compound active material having graphite particles with both a first size and a second size. Compound active material 410 includes graphite particles 430 having a diameter that falls within a range of 30 microns to 10 microns, and graphite particles 420 having a diameter of between 20 microns and 3 microns, as long as the diameter of particles 430 is larger than the diameter of particles 420. Having a plurality of graphite particle sizes allows an active material to exhibit benefits of both larger graphite particles and smaller graphite particles. In particular, the larger size graphite particles 430 provide for a beneficial mass transfer while the smaller size graphite particles 420 provide a higher charge transfer. As a result, a battery cell with an electrode made from the active material with different sized particles provides for better battery discharge and charge performance.

In some instances, the compound active material may include differing amounts of large particles and small particles. In some instances, the larger graphite particles 430 may make up more than 50% of the volume of active material 410, for example between 51%-95% of the slurry. Accordingly, the smaller graphite materials 420 may make up 50% or less of the volume of the compound active material 410, for example between 50% and 5% of the slurry.

Though two sizes of graphite particles are illustrated in the active material of 410 of FIG. 4, more sizes may be used within an active material. For example, an active material may be made of graphite particles having three, four, five, or some other number of different sizes (i.e., diameter). The active material, and battery cells with electrodes made from such active materials, are not intended to be limited to only two sizes of graphite particles.

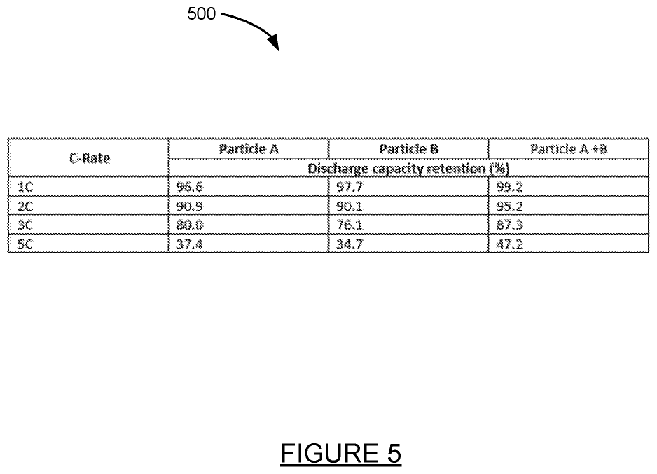

As discussed above, electrodes made from an active material of a single size particle do not perform as well at higher C-rates compared to lower C-rates. FIG. 5 is a table of discharge capacity for different C-rates and active materials. The table of FIG. 5 displays discharge capacity retention data for different C-rates and different active material compositions. An electrode with an active material with a single sized particle A can have a discharge capacity retention of 96.6% at a C-rate of 1 C. At 2 C, the discharge capacity retention is 90.9%, at 3 C the discharge capacity retention is 80%, and at 5 C the discharge capacity retention percentage for the active material made of particle a is 37.4%.

For an active material with a particle B having a second size that differs from the size of particle A, the discharge capacity retention is 97.7% at a C-rate of 1 C. The particle B has a discharge capacity retention of 90.1% at a C-rate of 2 C, discharge capacity retention of 76.1% at a C-rate of 3 C, and a discharge capacity retention of 34.7% at a C-rate of 5 C.

For an active material made of particles A and B which have different sizes (one with a diameter greater than the other), the discharge capacity retention at comparable C-rates are higher than those for active materials of a single particle size. For example, the discharge capacity retention for an active material with particles A and B, wherein one particle is greater than the other particle, is 99.2% for a C-rate of 1 C. The discharge capacity retention for the compound active material is 95.2% at a C-rate of 2 C, a discharge capacity retention of 87.3% for a C-rate of 3 C, and a discharge capacity retention of 47.2% and a C-rate of 5 C. Based on the data from the table of FIG. 5, the discharge capacity retention percentage for an active material made of particles having different sizes is between 25% to 35% greater at a high discharging rate of 5 C as compared to active materials with graphite particles having a single size.

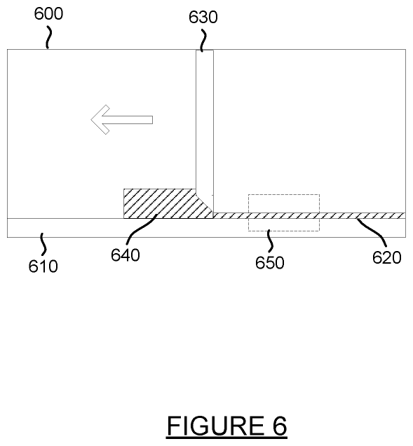

FIG. 6 is a block diagram of a system 600 for applying a slurry to a current conductor. The system of FIG. 6 is exemplary and for purposes of discussion only, and only illustrates selected portions of a typical electrode manufacturing system. System 600 includes current conductor 650, a reservoir of slurry 640, a blade 630, and slurry 620 that has been applied to the current conductor 620. The system 600 receives and/or supports the current conductor 610 and secures the current conductor so that it can receive an application of slurry 640 to a surface of the conductor. The current conductor 610 may include a sheet or foil of material, such as copper or aluminum.

A reservoir of slurry 640 may be applied as a thin film to current conductor 610 using a slurry applicator device, such as for example blade 630. The blade 630 may be moved in a direction (as shown by the arrow in FIG. 6) along the current conductor 610 at a particular height to create a thin-film on current conductor 610. The current conductor 610 may be comprised of different materials, depending on the type of electrode and the application. In some instances, an anode current conductor can be made of copper while a cathode current conductor can be made of aluminum.

The slurry 640 that is applied to the current conductor 610 may include a compound active material having graphite particles with a plurality of sizes. In some instances, some graphite particles may have a first size while some graphite particles may have a second size, wherein the first size is larger than the second size. The plurality of graphite particles materials may be such that they are well suited to be thoroughly mixed into the slurry.

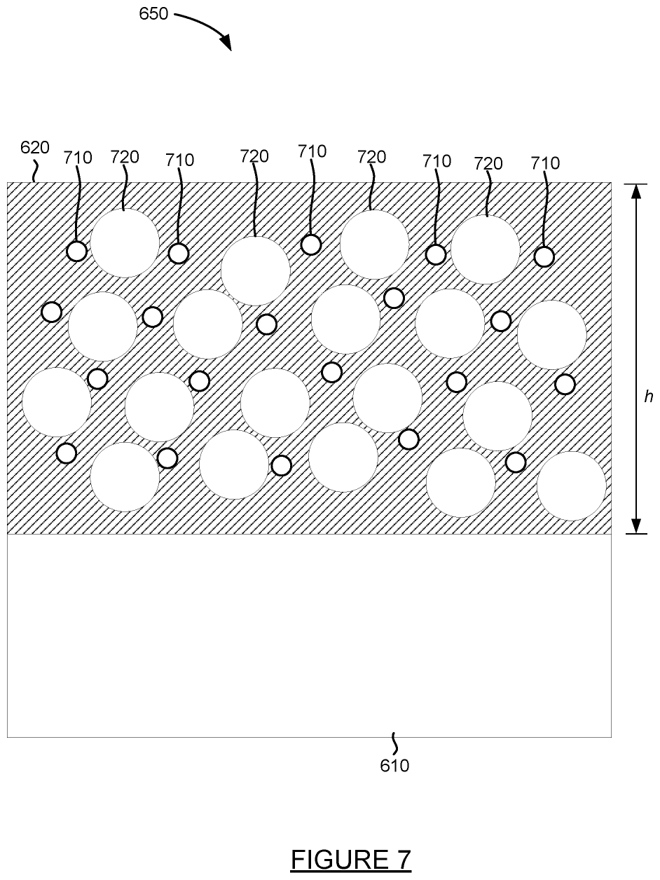

FIG. 7 is a block diagram of a portion of a slurry with a compound active material applied to a current conductor. The portion of slurry illustrated in FIG. 7 provides more detail of the slurry portion 650 in the block diagram of FIG. 6. The slurry 620 applied to current conductor 610 has a height h corresponding to the height of the blade 630 positioned above current conductor 610. Within the slurry, the active material has graphite particles 710 with a diameter of less the diameter of particles 720. The graphite particles making up the active material are dispersed throughout the slurry as shown in the slurry portion of FIG. 7.

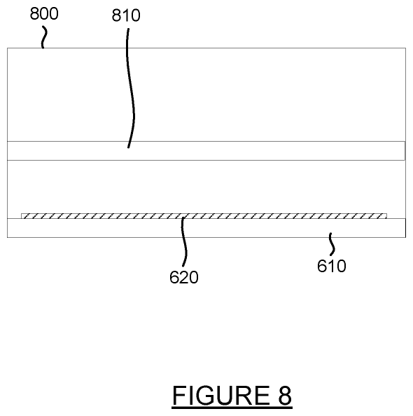

Once a slurry is applied, the slurry may be dried in a drying chamber. FIG. 8 is a block diagram of an electrode generation system drying a slurry that has been applied to a current conductor. Drying chamber 800 may receive a current conductor with a slurry thin film applied to a surface of the conductor. Once received, the drying chamber may dry the slurry. The slurry may be dried at a controlled temperature, such as for example room temperature or some other temperature.

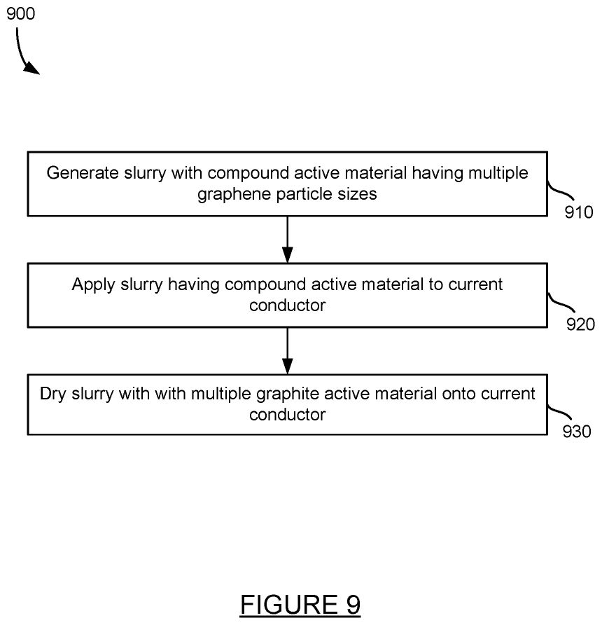

FIG. 9 is a method for manufacturing an electrode with a slurry having a compound active material. A slurry is generated with a compound active material having multiple graphite particle sizes at step 910. The multiple graphite particles may have a plurality of diameters. For example, a compound active material may include larger graphite particles having a diameter larger than the smaller graphite particles. In some instances, the larger graphite particles may have a diameter of between 8 and 40 μm, or a diameter of between 15 and 35 μm or a diameter of between 15 and 30 μm, or between 15 and 25 μm. In some instances, the graphite particles having a smaller diameter can have a diameter of less than 15 μm may have a diameter of between 15 and 10 μm or between 15 and 5 μm.

To generate the slurry with a multiple graphite active material, the active material comprised of multiple sized particles is mixed with a binder, such as for example carboxymethyl cellulose (CMC). The compound active material and binder may be mixed in a planetary mixer for a suitable amount of time to thoroughly mix the two materials, such as for example 30 minutes. In some instances, other materials such as another binder may be added to the mixed active material and binder, such as for example styrene-butadiene rubber (SBR). In some instances, one or more binders may comprise a smaller volume percentage than an active material. For example, a binder may make-up between 2% and 10% or between 2% and 30% of a slurry volume.

The slurry with the compound active material is then applied to the current conductor at step 920. The slurry may be applied with a blade which forms a slurry coating or thin film of a fixed height to a surface of the current conductor, as illustrated in the block diagram of FIG. 6. After applying the slurry, the slurry with the multiple graphite active materials is dried onto the current conductor at step 930. The slurry may be dried at room temperature or some other temperature that is suitable to try the slurry onto the current conductor. The resulting electrode can be further processed and/or modified and used as part of a rechargeable lithium ion battery cell.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. An electrode of a rechargeable battery cell, comprising:
a current conductor; and
a slurry coating on a first surface of the current conductor, the slurry including an active material having a first plurality of graphite particles that have a first diameter and a second plurality of graphite particles having a second diameter, the first diameter being larger than the second diameter.

2. The electrode of claim 1, wherein the first plurality of graphite particles comprises a greater volume of the slurry than the second plurality of graphite materials

3. The electrode of claim 1, wherein the first plurality of graphite particles comprises 51%-90% of the volume of the slurry.

4. The electrode of claim 1, wherein a majority of the first plurality of graphite particles have a diameter of between 10 microns and 30 microns.

5. The electrode of claim 1, wherein a majority of the second plurality of the graphite particles have a diameter of between 20 and 5 microns.

6. The electrode of claim 1, wherein the slurry is generated by adding the first plurality of graphite particles with the second plurality of graphite particles in the slurry.

7. The electrode of claim 1, wherein the slurry includes a binder material.

8. The electrode of claim 1, wherein the binder comprises between 2% to 10% of the slurry.

9. A method for manufacturing an electrode, comprising:
applying a slurry to a first surface of a current conductor, the slurry including an active material, a conductive material, and a binder, the active material including a first plurality of graphite particles having a first diameter and a second plurality of graphite particles having a second diameter, the first diameter larger than the second diameter; and
drying the slurry onto the current conductor.

10. The method of claim 9, wherein the first plurality of graphite particles comprises a greater volume of the slurry than the second plurality of graphite materials

11. The method of claim 9, wherein the first plurality of graphite particles comprises 51%-90% of the volume of the slurry.

12. The method of claim 9, wherein a majority of the first plurality of graphite particles have a diameter of between 10 microns and 30 microns.

13. The method of claim 9, wherein a majority of the second plurality of the graphite particles have a diameter of between 20 and 5 microns.

14. The method of claim 9, further comprising generating the slurry by adding the first plurality of graphite particles with the second plurality of graphite particles in the slurry.

15. The method of claim 14, wherein generating the slurry includes mixing the first plurality of graphite particles and the second plurality of graphite particles with a binder material.

16. The method of claim 15, wherein the binder comprises between 10% to 2% of the slurry.
